(19) United States
(12) Patent Application Publication
(10) Pub. No.: US 2006/0192408 A1
(43) Pub. Date: Aug. 31, 2006

(54) Retractable roof for a vehicle

(76) Inventors: Gerard Queveau, Le Pin (FR); Paul Queveau, Montravers (FR); Jean-Marc Guillez, Cirieres (FR)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 10/545,222

(22) PCT Filed: Feb. 9, 2004
(86) PCT No.: PCT/FR04/00293

§ 371 Date: Aug. 10, 2005

(30) Foreign Application Priority Data
Feb. 28, 2003 (FR) 03/02488

(51) Int. Cl. B60J 7/08

(52) U.S. Cl. 296/107.01

(57) ABSTRACT

The invention relates to a retractable roof for a vehicle, comprising at least one front element (2; 25, 26), a rear roof element (1) and two lateral roof elements (2; 24) which are rigid and which can be displaced by drive means provided in order to fold down the lateral roof elements in a substantially perpendicular manner in relation to the plane of symmetry of the vehicle about an axis of rotation which is substantially vertical. The drive means include a support plate (3) which is mounted on the rear roof element and a drive plate (4) which is coupled to one of the lateral roof elements and which is rotationally mounted on the support plate about said axis of rotation, whereby one of the plates comprises a finger (11; 20) which is engaged in a groove (6; 21) of the other plate and driving means (7; 23) are provided in order to displace the finger in relation to the plate bearing it such that the lateral roof element rotates in relation to the rear roof element by means of interaction of the finger with the groove.

### BACKGROUND OF THE INVENTION

This invention relates to a retractable vehicle roof comprising at least one front element, a rear roof element, and two rigid side roof elements, which elements are movable between a position in which they cover the passenger compartment of the vehicle and a position in which they are stowed in the rear trunk of the vehicle, drive means being provided for folding the side roof elements substantially perpendicularly to the plane of symmetry of the vehicle about a substantially vertical pivot axis.

Such a retractable roof makes it possible to transform a vehicle of the saloon or coupe type into a vehicle of the cabriolet type.

One of the difficulties encountered in designing such roofs lies in the system for driving the side roof elements. Another difficulty is the difficulty of locking the elements in a position in which they cover the passenger compartment.

### SUMMARY OF THE INVENTION

An object of the present invention is to mitigate those difficulties.

To this end, the invention provides a retractable vehicle roof comprising at least one front element, a rear roof element, and two rigid side roof elements, which elements are movable between a position in which they cover the passenger compartment of the vehicle and a position in which they are stowed in the rear trunk of the vehicle, drive means being provided for folding the side roof elements substantially perpendicularly to the plane of symmetry of the vehicle about a substantially vertical pivot axis, said retractable vehicle roof being characterized by the fact that said drive means comprise a support plate mounted on said rear roof element and a drive plate secured to one of the side roof elements mounted to pivot on said support plate about said pivot axis, one of said plates carrying a finger engaged in a groove of the other plate, motorized drive means being provided to move said finger relative to the plate that carries it so as to cause said side roof element to pivot relative to said rear roof element by said finger interacting with said groove.

It should be noted that the plate that carries the finger can be limited to means for moving and guiding the finger.

In a particular embodiment of the invention, said groove is formed in the drive plate.

Also in a particular embodiment of the invention, said finger is arranged to be moved in translation substantially rectilinearly.

More particularly, said finger is driven by a nut that is guided in translation and mounted on a threaded rotary shaft driven by an electric motor.

In another embodiment, said finger is driven by a co-operating rack driven by an electric motor.

Also in a particular embodiment of the invention, said electric motor is mounted in said rear roof element.

In another embodiment, said electric motor is mounted in said side roof element.

Said motorized drive means may be arranged to drive locking means for locking at least one roof element.

In particular, said locking means may comprise at least one thrust finger driven by a nut guided in translation and mounted on a threaded rotary shaft driven by said electric motor.

The roof of the invention may also be provided with runners arranged to co-operate with wheels that are secured to said roof elements, and said locking means comprising ramps on said rack that are arranged to lock said wheels on said runners.

### BRIEF DESCRIPTION OF THE DRAWINGS

By way of non-limiting example, a particular embodiment of the invention is described below by way of non-limiting example and with reference to the accompanying diagrammatic drawings, in which:

FIG. 1 is a perspective view of an embodiment of a device of the invention;

FIG. 2 is a plan view of another embodiment of the invention; and

FIG. 3 is a side view in section of a retractable roof of the invention, corresponding to the embodiment of FIG. 2.

### BRIEF DESCRIPTION OF THE DRAWINGS

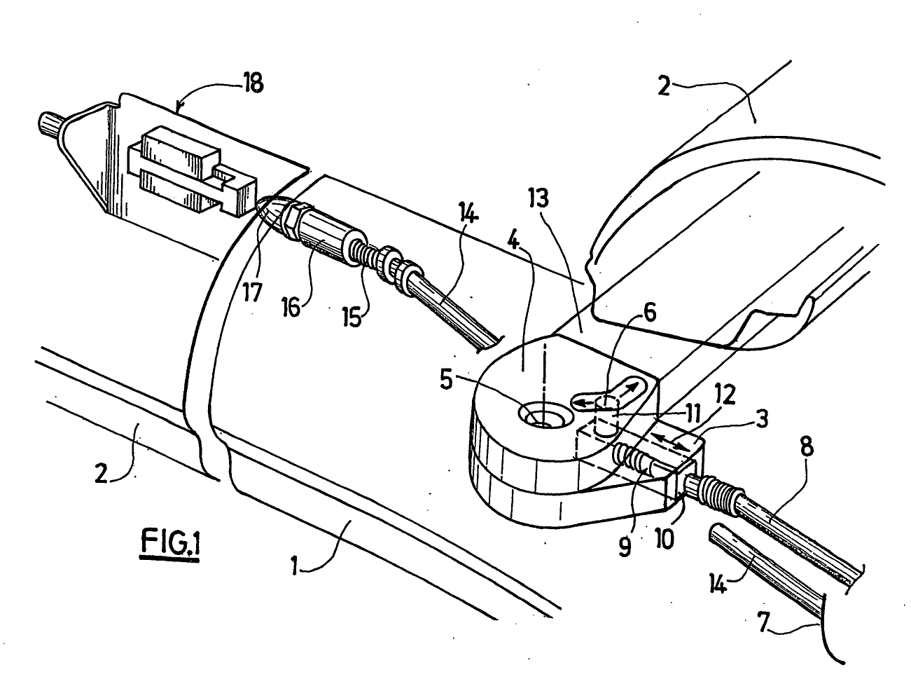

FIG. 1 shows the rear element 1 of a retractable roof, and the left side element 2 thereof.

A support plate 3 is fixed to the rear roof element 1. A drive plate 4 is mounted to pivot on the support plate 3 about an axis 5.

A cam-forming groove 6 is formed in the drive plate 4.

An electric motor 7 is also mounted in the rear element 1. A rod 8 is mounted on the outlet shaft of the motor, said rod having a threaded end 9.

The threaded end 9 of the rod 8 is engaged in a nut 10 guided in rectilinear translation in a recess in the support plate 3.

A finger 11 is secured to or integral with the nut 9, and can thus be moved in translation by the motor 7 in the direction indicated by arrow 12. The finger 11 is engaged in the groove 8 so that the finger 11 moving causes the drive plate 4 to pivot relative to the support plate 3.

An arm 13 is secured to the plate 4. The arm 13 carries the side roof element 2. Thus, the motor 7 can bring the element 2 from its covering position to its stowage position, and vice versa.

The motor 7 has a second outlet driving a rod 14. The end 15 of the rod 14 is threaded and co-operates with a nut 16 that is guided in translation. A thrust finger 17 is secured to the nut 16.

Roof-locking means 18 of any suitable type are actuated by the thrust finger 17.

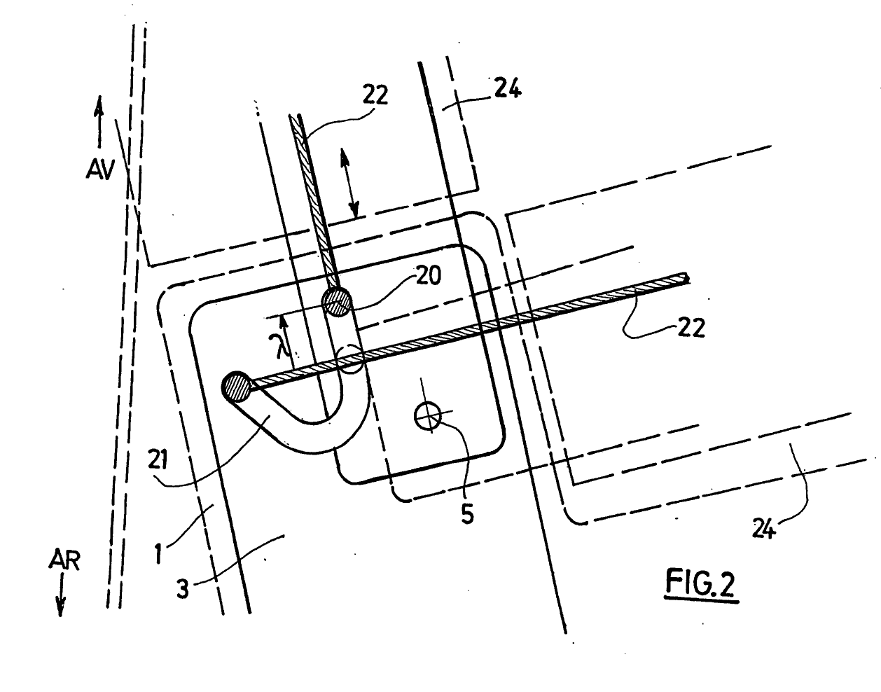

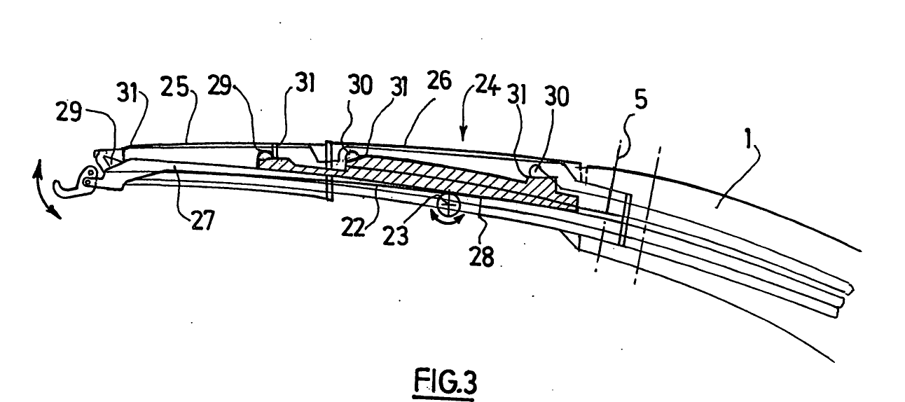

In the embodiment shown in FIGS. 2 and 3, the finger 20 engaged in the groove 21 is moved by a rack 22 actuated by an electric motor 23 received in the side roof element 24. The drive from the motor 23 thus, as in the preceding embodiment, causes the element 24 to pivot about the axis 5. The element 24 is shown in FIG. 2 in its covering position and in its stowage position.

The front roof elements 25 and 26 are mounted to slide in runners 27 and 28 in the side element 24, via wheels 29 and 30.

The rack 22 has ramps 31 suitable for coming to lock the wheels 29 and 30. In addition, the end of the rack 22 co-operates with a locking hook 32 on the top of the windscreen of the vehicle.

When the rack 22 is driven, it starts by unlocking the roof elements. Since the beginning of the groove 21 is rectilinear, the side element remains stationary. The front roof elements are then slid into the stowage position, and the finger causes the side element to pivot.

1. A retractable vehicle roof comprising at least one front element, a rear roof element, and two rigid side roof elements, which elements are movable between a position in which they cover the passenger compartment of the vehicle and a position in which they are stowed in the rear trunk of the vehicle, drive means being provided for folding the side roof elements substantially perpendicularly to the plane of symmetry of the vehicle about a substantially vertical pivot axis, said retractable vehicle roof being characterized by the fact that said drive means comprise a support plate mounted on said rear roof element and a drive plate secured to one of the side roof elements mounted to pivot on said support plate about said pivot axis, one of said plates carrying a finger engaged in a groove of the other plate, motorized drive means being provided to move said finger relative to the plate that carries it so as to cause said side roof element to pivot relative to said rear roof element by said finger interacting with said groove.

2. A retractable roof according to claim 1, in which said groove is formed in the drive plate.

3. A retractable roof according to claim 1, in which said finger is arranged to be moved in translation substantially rectilinearly.

4. A retractable roof according to claim 3, in which said finger is driven by a nut that is guided in translation and mounted on a threaded rotary shaft driven by an electric motor.

5. A retractable roof according to claim 3, in which said finger is driven by a co-operating rack driven by an electric motor.

6. A retractable roof according to claim 4, in which said electric motor is mounted in said rear roof element.

7. A retractable roof according to claim 4, in which said electric motor is mounted in said side roof element.

8. A retractable roof according to claim 1, in which said motorized drive means are arranged to drive locking means for locking at least one roof element.

9. A retractable roof according to claim 8, in which said locking means comprise at least one thrust finger driven by a nut guided in translation and mounted on a threaded rotary shaft driven by said electric motor.

10. A retractable roof according to claim 5, provided with runners arranged to co-operate with wheels that are secured to said roof elements, and in which said locking means comprise ramps on said rack that are arranged to lock said wheels on said runners.
